(19) United States
(12) Patent Application Publication
(10) Pub. No.: US 2023/0058514 A1
(43) Pub. Date: Feb. 23, 2023

(54) GRAPHIC ADVERTISEMENT CREATION PROCESS

(71) Applicant: Guillaume Andre Ellis, Vancouver (CA)

(72) Inventor: Guillaume Andre Ellis, Vancouver (CA)

(21) Appl. No.: 17/445,597

(22) Filed: Aug. 21, 2021

(51) Int. Cl. G06Q 30/02; G06F 16/435; G06F 16/71; G06F 16/74; G06T 11/60; G06T 3/40; G06F 40/109

(52) U.S. Cl. CPC G06Q 30/0276; G06F 16/435; G06F 16/71; G06F 16/74; G06T 11/60; G06T 3/40; G06F 40/109

(57) ABSTRACT

A graphic creation process that is operable to create an advertisement for use on the internet movie database, in particular in an internet movie database frame. The present invention provides a process for selecting and placing at least a first content and a second content within an internet movie database frame. The first content and second content are image files selected from available sources and are placed within an internet movie database frame utilizing suitable computer based tools. The internet movie database frame is divided into at least two sections utilizing the process of the present invention. A divider that can be either visible or invisible is employed to create at least two sections for placing content therein. Text images can be further added wherein the font can be adjusted to align with a desired mood or tone of the advertisement.

### FIELD OF THE INVENTION

The present invention relates generally to graphic advertising, more specifically but not by way of limitation, a graphic advertisement process configured to provide a customized format compliant graphic advertisement or image wherein the process of the present invention is focused on the Internet Movie Database(IMDb).

### BACKGROUND

The Internet Movie Database(IMDb) is an online database of information related to films, television programs, home videos, video games, and streaming content online. The IMDb includes information on the cast, production crew and personal biographies, plot summaries, trivia, ratings, and fan and critical reviews. An additional feature, message boards, was abandoned in February 2017. IMDb was originally a fan-operated website, however, the database is now owned and operated by IMDb.com, Inc., a subsidiary of Amazon. Currently, IMDb has millions of titles as well as millions of personalities in its database. Furthermore, IMDb currently has approximately ninety million registered users. IMDb began as a movie database on the Usenet group in 1990 and moved to the web in 1993.

Artists, actors, crew, and industry executives can post their own resume and upload photos of themselves which can cost an annual fee. These graphic images can include additional images such as but not limited to music video posters . IMDbPro is accessible to any fee-paying individual. IMDbPro allows existing artists to claim their name page which can be helpful in the area of advertising. Any registered IMDb user can contribute to the site as well as view its content. As the platform allows users to upload content, the result can be production of a graphic image that is both undesirable and not properly formatted. Artists, music labels and producers will upload a graphic poster to promote a video, artist or other event and current technology does not provide appropriate looks, moods, formats and dimensions. Conventional video posters do not format to the correct size for IMDb.

Accordingly, there is a need for a graphic creation process that provides a technique to display a music video poster or other graphic content wherein the graphic content is created and formatted from IMDb.

### SUMMARY OF THE INVENTION

It is the object of the present invention to provide a graphic creation process that provides an ability to display a music video poster in an IMDb frame wherein the present invention includes sourcing of graphic content from various sources and in a plurality of formats.

Another object of the present invention is to provide a process to create a graphic image formatted for display in an IMDb frame wherein the process of the present invention can utilize a graphic screenshot image from a music video or other video source.

A further object of the present invention is to provide a graphic creation process that provides an ability to display a music video poster in an IMDb frame wherein the resulting frame image includes a selected mood, tone and desired appearance.

Still another object of the present invention is to provide a process to create a graphic image formatted for display in an IMDb frame wherein the process of the present invention wherein the process incorporates graphic content from a plurality of sources.

An additional object of the present invention is to provide a graphic creation process that provides an ability to display a music video poster in an IMDb frame wherein the process includes a step of cropping and merging graphic content sources.

Yet a further object of the present invention is to provide a process to create a graphic image formatted for display in an IMDb frame wherein the process of the present invention further includes the step of selecting fonts for text portions of the final graphic IMDb frame graphic.

Another object of the present invention is to provide a graphic creation process that provides an ability to display a music video poster in an IMDb frame that further includes the step of utilizing a text or graphic image to mask a visible area of combined graphic content.

An alternative object of the present invention is to provide a process to create a graphic image formatted for display in an IMDb frame wherein the process of the present invention employs a dividing step so as to divide a IMDb frame into two or more sections.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is an exemplary graphic advertisement created by the process of the present invention; and

FIG. 2 is a flowchart of an exemplary process of the present invention; and

FIG. 3 is a flowchart of an alternative exemplary process of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a graphic creation process 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

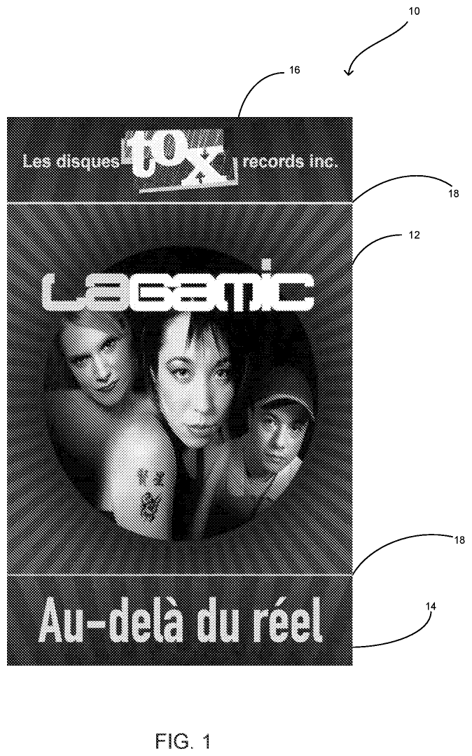

Referring in particular to the Figures submitted as a part hereof, the graphic creation process 100 is a process to create an advertisement presentable within an IMDb frame wherein the present invention utilizes graphical content from various sources in order to create the desired IMDb advertisement 10. The IMDb advertisement is a graphical image in the format required for IMDb. The present invention provides a process to include image files, text and other desired content to be displayed within the IMDb advertisement. The IMDb advertisement 10 includes a first section 12, second section 14 and third section 16. The first section 12, second section 14 and third section 16 are segmented by dividers 18. The dividers 18 are graphical lines or other suitable element that function to divide the IMDb frame into desired sections. It should be understood within the scope of the present invention that the IMDb advertisement 10 could have no dividers 18 or more than two as is illustrated herein in FIG. 1. Furthermore, it should be understood within the scope of the present invention that the dividers 18 could be a visible element or could be invisible in the overall graphical content. The dividers 18 provide a technique to partition the IMDb frame in order to subsequently place the desired graphical content therein. It should be understood within the scope of the present invention that the IMDb advertisement 10 could employ dividers 18 or be created without utilization of dividers 18.

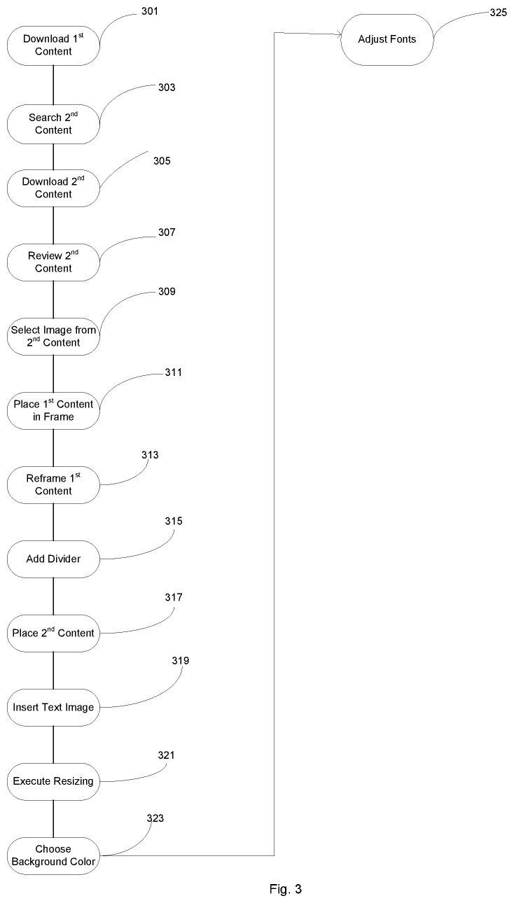

Now referring in particular to FIG. 3, an exemplary process of the graphic creation process 100 is diagrammed therein. In step 301, a first content is identified and downloaded from a desired source. It should be understood within the scope of the present invention that the first content could be an image data file of a music single cover or other desired graphical image that can be downloaded from various sources. Step 303, a user will search for second content. It should be understood within the scope of the present invention that the second content could be but is not limited to logos or a music video that can be found on available resources. In step 305, ensuing identification of desired second content, the user will download the desired second content. Step 307, the user will review the second content and select a portion thereof to be utilized for creation in the IMDb advertisement 10. By way of example but not limitation, the user may have selected a music video for the second content. If a music video has been selected for the second content, the user will review the frames of the music video and identify a desired frame from the music video to utilize as the second content.

In step 309, the user will select an image from the second content data file. This could be a frame of a music video or if alternate second content sources were utilized then either all or a portion thereof could be selected by a user to be utilized as the second content. Step 311, a user will place the first content in the IMDb frame. Step 313, the first content will be reframed so as to be of proper size as required for the IMDb frame. This can include but is not limited to cropping and resizing of the first content. In step 315, a user will add a divider 18. It should be understood within the scope of the present invention that the divider 18 could be installed within the IMDb frame initially prior to adding either the first content or second content. Additionally, it should be understood within the scope of the present invention that more than one divider 18 could be employ to create as many sections as desired. Furthermore, it is contemplated within the scope of the present invention that the divider 18 could be either a visible element or an invisible element.

In step 317, the user will place the second content within the IMDb frame. The second content is placed in a second section that has been created through employment of at least one divider 18. Step 319, the user can choose to insert a text image. The text image can be placed in any section of the IMDb frame and can be include any desired text either within a defined text image box or as text only image. In step 321, the text image is resized in order to create the desired graphical appearance so as to be congruent with the overall graphical image of the IMDb advertisement 10. It should be understood within the scope of the present invention that the text image could be resized in various different manners in order to achieve the desired objective. Step 323, if desired a background color for the IMDb advertisement 10 can be selected and employed. It should be understood within the scope of the present invention that a background color could be selected and installed in any section of the IMDb frame at any point in the process of the present invention. In step 325, a user will adjust the fonts of any text image added to any section of the IMDb advertisement 10 in order to align with the desired mood or tone of the IMDb advertisement 10.

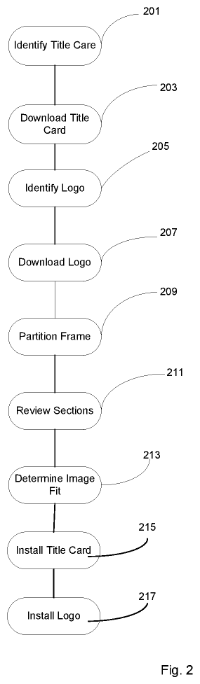

Referring now to FIG. 2 submitted as a part hereof, an alternative embodiment of the graphic creation process 100 is diagrammed therein. In step 201, a user will identify from an appropriate resource a title card of a music video. Step 203, the user will download the title card for subsequent use thereof. In step 205, the user will identify a logo from an appropriate resource. It should be understood within the scope of the present invention that the logo could be an image of either a musician, band or of an individual song. Step 207, the user will download the logo for subsequent use thereof. In step 209, the user will partition an IMDb frame as desired for insertion of content. It should be understood within the scope of the present invention that the IMDb frame could be partitioned into two or more sections. Furthermore, it should be understood within the scope of the present invention that the partitions could be divided utilizing either a visible graphic such as but not limited to a line or an invisible graphic.

In step 211, the user will review the sections to ensure desired size thereof.

Step 213, the user will determine imaging fitting of the sections so as to be graphically desirable upon placement of the title card and the logo. Step 215, the user will place the graphical image of the title card in the desired section and execute any resizing thereof as needed in order to comply with the IMDb frame size. In step 217, the user will place the logo image in the second section of the IMDb frame. It should be understood within the scope of the present invention that the logo image could be placed such that the image is replicated within the section in order to fill the selected section and maintain a properly formatted appearance thereof.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A graphic creation process to create a graphic image for an internet movie database frame wherein the graphic creation process comprises the steps of:
searching for a first content, wherein the first content is an image file capable of being located on a publicly available database;
reviewing sources for a second content, wherein the second content can be an image file or a text file;
downloading the first content and the second content, wherein the first content and second content are downloaded to a computing device of a user;
dividing the internet movie database frame, wherein the internet movie database frame is divided into at least two sections;
placing the first content within the internet movie database frame;
placing the second content within one of the at least two sections in the internet movie database frame;
editing the first content and the second content; wherein the first content and second content are edited to fit within the at least two sections; and
posting the internet movie database frame to the internet movie database.

2. The graphic creation process to create a graphic image for an internet movie database frame as recited in claim 1, and further including the step of inserting a text image, wherein the text image can be inserted into one of the at least two sections.

3. The graphic creation process to create a graphic image for an internet movie database frame as recited in claim 2, and further including the step of reviewing the second content for a desired image to be placed in one of the at least two section of the internet movie database frame.

4. The graphic creation process to create a graphic image for an internet movie database frame as recited in claim 3, wherein the second content is a music video.

5. The graphic creation process to create a graphic image for an internet movie database frame as recited in claim 4, and further including the step of selecting a frame of the music video to be placed in one of the at least two sections.

6. The graphic creation process to create a graphic image for an internet movie database frame as recited in claim 3, and further including the step of resizing the first content so as to be properly formatted into one of the at least two sections in which the first content will be placed.

7. The graphic creation process to create a graphic image for an internet movie database frame as recited in claim 6, and further including the step of selecting a background color for the at least two sections of the internet movie database frame.

8. The graphic creation process to create a graphic image for an internet movie database frame as recited in claim 7, wherein the step of dividing the internet movie database frame includes utilization of a divider.

9. The graphic creation process to create a graphic image for an internet movie database frame as recited in claim 8, wherein the divider is either a visible graphic or invisible graphic.

10. The graphic creation process to create a graphic image for an internet movie database frame as recited in claim 9, and further including the step of adjustment of fonts of the text image in order to create mood and tone thereof.

11. The graphic creation process to create a graphic image for an internet movie database frame as recited in claim 3, wherein the second content is an image file of a logo.

12. The graphic creation process to create a graphic image for an internet movie database frame as recited in claim 11, wherein the image file of the logo can be placed within one of the at least two sections such that the image file of the logo is a single image or that the image file of the logo is replicated within the at least one of the at least two sections a plurality of times.

13. The graphic creation process to create a graphic image for an internet movie database frame as recited in claim 12, wherein the first content can be a title card of a song.

14. The graphic creation process to create a graphic image for an internet movie database frame as recited in claim 12, wherein the divider extends horizontally across the internet movie database frame.
